(19) United States
(12) Patent Application Publication
(10) Pub. No.: US 2017/0177950 A1
(43) Pub. Date: Jun. 22, 2017

(54) METHOD AND DEVICE FOR CREATING A MAP

(71) Applicant: Robert Bosch GmbH, Stuttgart (DE)

(72) Inventor: Carsten Hasberg, Ilsfeld-Auenstein (DE)

(21) Appl. No.: 15/377,669

(22) Filed: Dec. 13, 2016

(30) Foreign Application Priority Data
Dec. 16, 2015 (DE) 102015225472.0

(51) Int. Cl. G06K 9/00; G06K 9/52; G06T 7/73; G06T 7/11

(52) U.S. Cl. CPC G06K 9/00791; G06K 9/00476; G06T 7/11; G06K 9/52; G06T 7/73; G06T 2215/16; G06T 2207/20112; G06T 2207/30252

(57) ABSTRACT

A method and devices for creating a map, including the following method steps: recording at least two driving environment data sets; these at least two driving environment data sets representing the driving environment of at least one vehicle; evaluating the at least two driving environment data sets; creating at least two map segments; transmitting the at least two evaluated driving environment data sets and the at least two map segments; receiving the at least two evaluated driving environment data sets and the at least two map segments; and creating a map from the at least two evaluated driving environment data sets and the at least two map segments.

### RELATED APPLICATION INFORMATION

The present application claims priority to and the benefit of German patent application no. 10 2015 225 472.0, which was filed in Germany on Dec. 16, 2015, the disclosure of which is incorporated herein by reference.

### FIELD OF THE INVENTION

The present invention relates to a method, as well as to devices for creating a map.

### BACKGROUND INFORMATION

German Patent Application DE 10 2013 208 521 A1 discusses a method for collectively learning and creating a digital road model. Trajectory and perception data are thereby recorded by a multiplicity of vehicles. Associations are created among the trajectories by producing features grids and probability-field features grids for corresponding trajectory points to be associated, and correlating them to make association hypotheses. An information graph is produced on the basis of the associations, as well as on the basis of odometric and position measurements, and the corresponding optimization objective for estimating optimal trajectory points is achieved. The recorded perception data are assessed on the basis of the estimated trajectory points, and are aggregated and merged to create a highly precise road model.

The document “A Tutorial on Graph-Based SLAM: Giorgio Grisetti Rainer Kümmerte Cyrill Stachniss Wolfram Burgard, Department of Computer Science, University of Freiburg, 79110 Freiburg, Germany” generally discusses what is referred to as the graph-based SLAM method. It is a method involving a simultaneous localization and mapping (SLAM).

### SUMMARY OF THE INVENTION

A first method according to the present invention for creating a map includes a step for recording at least two driving environment data sets, these at least two driving environment data sets representing the driving environment of at least one vehicle, a step of evaluating the at least two driving environment data sets, and a step of creating at least two map segments. The method according to the present invention also includes a step of transmitting the at least two evaluated driving environment data sets and the at least two map segments, a step of receiving the at least two evaluated driving environment data sets and the at least two map segments, as well as a step of creating a map from the at least two evaluated driving environment data sets and the at least two map segments.

A second method according to the present invention for transmitting data sets for mapping includes a step of recording at least two driving environment data sets, these at least two driving environment data sets representing the driving environment of at least one vehicle, a step of evaluating the at least two driving environment data sets, a step of creating at least two map segments from the at least two driving environment data sets and the at least two evaluated driving environment data sets, as well as a step of transmitting the at least two evaluated driving environment data sets and the at least two map segments.

A third method according to the present invention for receiving data sets and for mapping includes a step of receiving the at least two evaluated driving environment data sets and the at least two map segments, and a step of creating a map from the at least two evaluated driving environment data sets and the at least two map segments.

In the method according to the present invention, a map may be understood to be both a visual medium, as well as data that are present, for example, in a memory of a processing unit, for creating a (digital) map, respectively for performing map-based computing operations, such as calculating a route.

A map segment is understood here to be a map that covers the sensor range of the least one vehicle. Thus, for example, two map segments, that were created on the basis of data generated by two different vehicles along the same trajectory, nevertheless cover different areas which, for example, may be associated with different sensors. In addition, two map segments may also differ when the same vehicle travels the same trajectory twice, but different weather conditions prevail, for example, that influence the recording of the driving environment data sets that are needed in order to use the map segments. In contrast, in comparison to the map segments described above, a (complete) map is understood to be something that covers a larger area that exceeds the sensor range of an individual vehicle.

The advantages of the inventive method reside in that a digital map is created using fleets of production vehicles. In principle, this means that, instead of individual mapping vehicles, every vehicle may be used for mapping, in that, for mapping, relevant data are collected in the vehicles, and subsequently transmitted effectively and in a resource-saving manner in accordance with the described method to an external processing unit, where a map is created from these data. It turns out to be a significant advantage that the existing SLAM graph-based methods are further refined by the described methods accordingly in that the individual method steps are restructured.

The at least two driving environment data sets may be each recorded in a way that each of them includes at least one driving environment feature, which is recorded together with the distance thereof relative to the at least one vehicle.

The at least two recorded driving environment data sets may be evaluated in a way that at least two positions and/or at least two position curves of the at least one vehicle are determined.

The at least two positions and/or the at least two position curves of the at least one vehicle may be determined by the distance relative to the at least one driving environment feature.

One specific embodiment provides that the at least two map segments be created in a way that uses at least two recorded driving environment data sets and the at least two evaluated driving environment data sets for the creation process.

One specific embodiment provides that the at least two map segments be created in a way that uses the at least two recorded driving environment data sets, the at least two evaluated driving environment data sets, as well as the at least two positions, and/or the at least two position curves of the at least one vehicle.

The at least two evaluated driving environment data sets, and the at least two created map segments are transmitted to a processing unit that is external to the vehicle.

The map may be created from the at least two evaluated driving environment data sets and from the at least two created map segments in a way that the at least two evaluated driving environment data sets and/or the at least two map segments are optimized for mapping purposes.

One specific embodiment provides that the map be created from the at least two evaluated driving environment data sets and from the at least two created map segments in a way that the at least two evaluated driving environment data sets include at least one driving environment feature and at least two position curves, each position curve including at least a starting position and an end position, of the at least one vehicle, and that the at least two position curves are optimized into one position curve for the mapping.

The mapping may be carried out from the at least two evaluated driving environment data sets and from the at least two created map segments in a way that the at least two position curves are optimized into one position curve to implement the mapping in a way that optimizes the distances between the at least two positions and the at least one driving environment feature.

A device according to the present invention for a vehicle for recording, evaluating, and transmitting data sets and for mapping includes a recording arrangement for recording at least two driving environment data sets, these at least two driving environment data sets representing the driving environment of at least one vehicle, and an evaluation arrangement for evaluating the at least two driving environment data sets. It also includes a creating arrangement for creating at least two map segments from the at least two driving environment data sets and the at least two evaluated driving environment data sets, as well as a transmitting arrangement for transmitting the at least two evaluated driving environment data sets and the at least two map segments.

Another device according to the present invention for receiving data sets and for creating a map includes a receiving arrangement for receiving the at least two evaluated driving environment data sets and the at least two map segments, and a creating arrangement for creating a map from the at least two evaluated driving environment data sets and the at least two map segments.

The devices according to the present invention may be configured for implementing a method in accordance with at least Claims 4 through 12.

Advantageous embodiments of the present invention are set forth in the dependent claims and delineated in the Specification.

Exemplary embodiments of the present invention are illustrated in the drawing and are explained in greater detail in the following description.

### BRIEF DESCRIPTION OF THE DRAWINGS

FIG. 1 shows an exemplary device according to the present invention for a vehicle for recording, evaluating, and transmitting data sets and for creating a map.

FIG. 2 shows an exemplary device according to the present invention for receiving data sets and for creating a map.

FIG. 3 shows an exemplary embodiment in the form of a flow chart.

### DETAILED DESCRIPTION

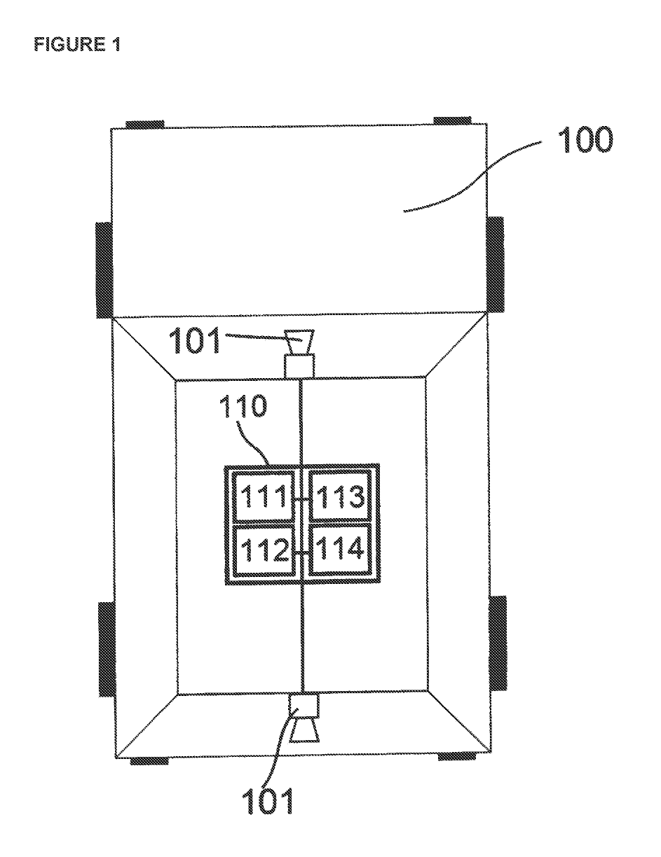

FIG. 1 shows a device (110) according to the present invention for a vehicle (100) for recording, evaluating, and transmitting data sets and for creating a map. For this purpose, device (110) includes recording arrangement (111) for recording at least two driving environment data sets; these at least two driving environment data sets representing the area surrounding at least one vehicle. For this purpose, it is possible to use the recording arrangement (111) as such, in that these include the relevant sensors such as video and/or radar and/or lidar and/or ultrasonic sensors. Furthermore, the recording arrangement (111) may also be configured to be connectable to sensors (101) that already exist, respectively are installed on and/or in vehicle (100), and to use the same to record the driving environment features.

The driving environment is understood to be everything that may be recorded by sensors (101, 111) of the at least one vehicle (100), such as the course of the road, for example, buildings in the vicinity of the road, elements of the road-traffic infrastructure, such as traffic signs, and driving environment features, such as woods, lakes, and mountains. The relevance of the features required for a possible method may also depend on the sensor type used for recording the driving environment of the at least one vehicle (100).

Device (110) also includes evaluation arrangement (112) for evaluating the at least two driving environment data sets. The driving environment data sets are thereby evaluated, for example, by extracting the driving environment contained in the data sets in the form of driving environment features and naming them, respectively storing them in a memory of evaluation unit (112) and/or in another memory of device (110) or of vehicle (100). In addition, evaluation arrangement (112) is configured, for example, in such a way that a graph, thus a possible trajectory, that the at least one vehicle (100) travels and/or has traveled, is created, respectively computed using the extracted driving environment features. This may be accomplished, for example, in such a way that the driving environment features from the driving environment of vehicle (100) recorded by recording arrangement (111) are structured correspondingly, for example, by taking into account the sequence in which the particular features are recorded and/or by considering the distance of vehicle (100) from the particular features.

In addition, evaluation arrangement (112) is configured in such a way that the driving environment data sets are compressed, for example, so that they may be more readily transmitted. This may include both the relaying of the driving environment data sets to existing arrangements (111, 112, 113, 114) included in device (110) and/or vehicle (100), as well as the transmission of the data sets to external processing units, for example via transmitting arrangement (114). Compressing the data may be understood both as the usual compression of electronic data in accordance with current compression methods, respectively current data compression programs, as are customary in electronic data processing, as well as reducing the data sets by extracting individual features (relevant to the method), and transmitting, respectively relaying only these, as already described above.

Device (110) also includes creating arrangement (113) for creating at least two map segments from the at least two driving environment data sets and the at least two evaluated driving environment data sets. Both the unprocessed driving environment data sets, as well as the processed data sets, for example, in the form of the extracted driving environment features, are thereby used. Because at least two driving environment data sets are used, at least two map segments are created by using each driving environment data set, as well as the driving environment features extracted therefrom, to create a map. A map may be thereby created, for example, by using the course of the trajectory of the at least one vehicle (100), as well as the distances of the utilized driving environment features from the at least one vehicle (100), in the mapping calculations. In the process, it is possible to revert to using current programs for creating a map and/or map segment, as well as to use special programs that are able to utilize the unprocessed driving environment data sets and/or the extracted driving environment features and/or compressed data sets.

In addition, device (100) includes transmitting arrangement (114) for transmitting the at least two evaluated driving environment data sets and the at least two map segments. Before the data are transmitted, it is possible, for example, to compress them again by reverting to evaluation arrangement (112) or by using an arrangement provided for this purpose which are included in transmitting arrangement (114).

In addition, transmitting arrangement (114) may themselves be configured accordingly, for example, to be able to transmit data by wireless link and/or access transmission possibilities already present in the at least one vehicle (100) in order to transmit the (compressed) data sets and/or the (compressed) map segments.

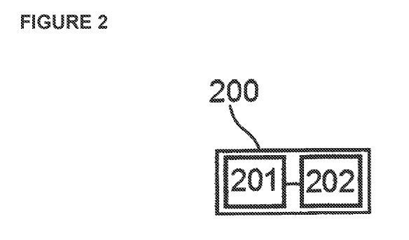

FIG. 2 shows exemplarily a device (200) according to the present invention for receiving data sets and for creating a map. Device (200) in this instance includes receiving arrangement (201) for receiving the at least two evaluated driving environment data sets and the at least two map segments.

In addition, device (110) includes creating arrangement (202) for creating a map from the at least two evaluated driving environment data sets and the at least two map segments. The received and evaluated driving environment data sets, as well as the received map segments are combined, so that a single graph is formed from the graphs contained in the map segments, this graph being optimized on the basis of the received driving environment data sets, as well as the received map segments. This optimization may be implemented, for example, by weighting the individual graphs and computing an average graph therefrom. The final map is finally created on the basis of the individual map segments of the at least one vehicle (100) and the optimized graph.

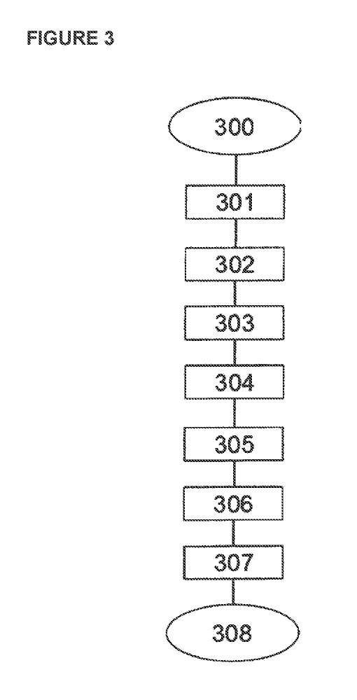

A flow chart of a method according to the present invention is shown exemplarily in FIG. 3.

The method begins in step 300.

In step 301, the driving environment of at least one vehicle (100) is recorded at least twice in the form of at least two driving environment data sets.

In step 302, driving environment features are extracted from the at least two driving environment data sets.

In step 303, at least two map segments are created from the at least two driving environment data sets as well as from the driving environment features extracted in each case. These two map segments each include a graph, for example, in the form of a trajectory of the at least one vehicle (100).

The driving environment data sets are compressed in step 304.

In step 305, the compressed driving environment data sets as well as the created map segments are transmitted to an external processing unit. This external processing unit may be a server, for example, that the at least one vehicle (100) is able to access via a communication connection in such a way that transmitted data are able to be received from the at least one vehicle (100).

In step 306, the external processing unit receives the compressed driving environment data sets as well as the created map segments.

In step 307, the individual graphs are combined, and an optimized graph is computed therefrom. Finally, a final map is created from the optimized graph, the received driving environment features, and the map segments.

The method ends in step 308.

What is claimed is:

1. A method for creating a map, the method comprising:
recording at least two driving environment data sets, the at least two driving environment data sets representing the driving environment of at least one vehicle;
evaluating the at least two driving environment data sets;
creating at least two map segments;
transmitting the at least two evaluated driving environment data sets and the at least two map segments;
receiving the at least two evaluated driving environment data sets and the at least two map segments; and
creating a map from the at least two evaluated driving environment data sets and the at least two map segments.

2. A method for transmitting data sets to create a map, the method comprising:
recording at least two driving environment data sets, the at least two driving environment data sets representing the driving environment of at least one vehicle;
evaluating the at least two driving environment data sets;
creating at least two map segments from the at least two driving environment data sets and the at least two evaluated driving environment data sets; and
transmitting the at least two evaluated driving environment data sets and the at least two map segments.

3. A method for receiving data sets to create a map, comprising the following steps:
receiving the at least two evaluated driving environment data sets and the at least two map segments; and
creating a map from the at least two evaluated driving environment data sets and the at least two map segments.

4. The method of claim 1, wherein the at least two driving environment data sets are each recorded in a way that the at least two driving environment data sets each include at least one driving environment feature, which is recorded together with the distance thereof relative to the at least one vehicle.

5. The method of claim 1, wherein the at least two recorded driving environment data sets are evaluated so that at least two positions and/or at least two position curves of the at least one vehicle are determined.

6. The method of claim 4, wherein the at least two positions and/or the at least two position curves of the at least one vehicle are determined by the distance relative to the at least one driving environment feature.

6. The method of claim 1, wherein the at least two map segments are created in a way that uses the at least two recorded driving environment data sets and the at least two evaluated driving environment data sets for the creation process.

7. The method of claim 6, wherein the at least two map segments are created using the at least two recorded driving environment data sets, the at least two evaluated driving environment data sets and the at least two positions and/or the at least two position curves of the at least one vehicle for the creation process.

8. The method of claim 1, wherein the at least two evaluated driving environment data sets and the at least two created map segments are transmitted to a processing unit that is external to the vehicle.

9. The method of claim 1, wherein the map is created from the at least two evaluated driving environment data sets and from the at least two created map segments so as to optimize the at least two evaluated driving environment data sets and/or the at least two map segments to create the map.

10. The method of claim 1, wherein the map is created from the at least two evaluated driving environment data sets and from the at least two created map segments so that the at least two evaluated driving environment data sets include at least one driving environment feature and at least two position curves, each position curve including at least a starting position and an end position, of the at least one vehicle, and wherein the at least two position curves are optimized into one position curve to create the map.

11. The method of claim 11, wherein the map is created from the at least two evaluated driving environment data sets and from the at least two created map segments so that the at least two position curves are optimized into one position curve to create the map so as to optimize the distances between the at least two positions and the at least one driving environment feature.

12. A device for a vehicle for recording, evaluating, and transmitting data sets and for creating a map, comprising:
a recording arrangement to record at least two driving environment data sets, the at least two driving environment data sets representing the driving environment of at least one vehicle;
an evaluating arrangement to evaluate the at least two driving environment data sets;
a creating arrangement to create at least two map segments from the at least two driving environment data sets and the at least two evaluated driving environment data sets; and
a transmitting arrangement to transmit the at least two evaluated driving environment data sets and the at least two map segments.

13. A device for receiving data sets and for creating a map, comprising:
a receiving arrangement to receive the at least two evaluated driving environment data sets and the at least two map segments; and
a creating arrangement to create a map from the at least two evaluated driving environment data sets and the at least two map segments.
